(19) United States
(12) Patent Application Publication
(10) Pub. No.: US 2016/0033728 A1
(43) Pub. Date: Feb. 4, 2016

(54) HYBRID POLARIZATION-MULTIPLEXED COHERENT PIC TRANSMITTERS AND RECEIVERS

(71) Applicants: Frederick A. Kish, JR., Palo Alto, CA (US); Mehrdad Ziari, Pleasanton, CA (US); Timothy Butrie, Hellertown, PA (US)

(72) Inventors: Frederick A. Kish, JR., Palo Alto, CA (US); Mehrdad Ziari, Pleasanton, CA (US); Timothy Butrie, Hellertown, PA (US)

(73) Assignee: Infinera Corporation, Sunnyvale, CA (US)

(21) Appl. No.: 14/678,690

(22) Filed: Apr. 3, 2015

Related U.S. Application Data
(60) Provisional application No. 61/974,970, filed on Apr. 3, 2014.

(51) Int. Cl. G02B 6/42; G02B 6/32; G02B 27/28; G02B 6/12; G02B 26/00; G02B 26/08; G02B 6/27; G02B 6/293

(52) U.S. Cl. CPC G02B 6/4226; G02B 6/272; G02B 6/2766; G02B 6/2773; G02B 6/32; G02B 6/4213; G02B 6/2938; G02B 6/4257; G02B 6/12004; G02B 26/00; G02B 26/0875; G02B 27/286

(57) ABSTRACT

Consistent with the present disclosure, active devices, such as lasers, optical amplifiers, and photodiodes, are integrated on a first substrate, and other optical devices, such as passive devices including polarization rotators and polarization beam combiners, are provided on a second substrate. An array of lenses is provided between the two substrates to provide a low loss optical connection from the first substrate to the second substrate. In addition, the orientation or position of the lenses can be readily controlled with Microelectromechnical System (MEMS) actuators so that the light can be directed precisely to a desired optical element, such as a waveguide. Consistent with a further aspect of the present disclosure, the lenses may be controlled to be misaligned by varying degrees in order to control the amount of light that is supplied from one substrate to another. Accordingly, the lenses may act as variable optical attenuators to provide uniform optical power levels, for example, or any desired power distribution.

This application claims the benefit of Provisional Patent Application No. 61/974,970 filed on Apr. 3, 2014, the entire contents of which are incorporated herein by reference.

### BACKGROUND

The present disclosure is generally directed toward various applications in which one or more lenses may be used to couple light from one device to another.

Wavelength Division Multiplexed (WDM) optical communication systems are known in which multiple optical sources transmit corresponding optical signals, each at a respective wavelength. The optical signals may be combined with an optical multiplexer and transmitted along an optical fiber to a receive node. At the receive node, the optical signals are separated from one another or demultiplexed, and each demultiplexed optical signals is supplied to a corresponding receiver, which may include a photodiode, or in the case of coherent detection, a Local Oscillator (LO) is used to select desired receiver signal. Each receiver, in turn, generates an electrical signal in response to the received optical signal which is then processed further.

Photonic integrated circuits (PICs) have been developed in which some of the devices of the WDM optical communication system have been integrated onto a common substrate. For example, optical sources including lasers and modulators, as well as optical combining elements, such as arrayed waveguide gratings (AWGs) and power combiners, have been integrated onto a common semiconductor substrate to provide a transmitter (PIC). Receiver PICs have also been developed in which optical demultiplexers, power splitters, and photodiodes, as well as devices required for coherent detection such as a Local Oscillator (LO), have also been integrated onto a common substrate. In polarization multiplexed systems, in which light having different polarizations is modulated and combined to provide increased capacity, polarization beam combiners (PBGs), polarization rotators, and polarization beam splitters (PBSs) have also been integrated onto the transmitter and receiver PICs.

As the number of integrated optical elements increases, the complexity and expense of fabricating the PICs also increases. For example, complicated waveguide structures that direct light from one element to the next on the PIC with low loss and distortion are typically required to be provided on the PIC.

### SUMMARY

Consistent with the present disclosure, an apparatus is provided that comprises a first substrate, and second through fourth substrates provided on the first substrate. An optical source, including a laser, is provided on the second substrate, the optical source outputting first and second optical signals from the second substrate. The device further includes a lens provided on the third substrate. The lens directs the first and second optical signals to first and second waveguides, respectively. The first and second waveguides are provided on the fourth substrate. A rotator is provided on the fourth substrate and is configured to rotate a polarization of the first optical signal to provide a rotated optical signal. In addition, a polarization beam combiner is provided on the fourth substrate. The polarization beam combiner receiving the rotated optical signal and said at least a portion of the second optical signal and outputting a polarization multiplexed optical signal.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) and together with the description, serve to explain the principles of the invention.

### BRIEF DESCRIPTION OF THE DRAWINGS

FIG. 1 illustrates a block diagram of an optical communication system consistent with the present disclosure;

FIG. 2 illustrates a detailed view of a transmitter block consistent with the present disclosure;

FIGS. 3a-3d illustrate operational modes of components in the transmitter block shown in FIG. 2 consistent with a further aspect of the present disclosure;

FIG. 4. Illustrates a receiver block consistent with an aspect of the present disclosure;

FIGS. 5a and 5b illustrate examples of cross-sectional views of the transmitter block shown in FIG. 2; and

FIG. 6 illustrates an example of a transceiver consistent with the present disclosure.

### DESCRIPTION OF THE EMBODIMENTS

Consistent with the present disclosure, active devices, such as lasers, optical amplifiers, and photodiodes, are integrated on a first substrate, and other optical devices, such as passive devices including polarization rotators and polarization beam combiners, are provided on a second substrate. An array of lenses is provided between the two substrates to provide a low loss optical connection from the first substrate to the second substrate. In addition, the orientation or position of the lenses can be readily controlled with Microelectromechnical System (MEMS) actuators so that the light can be directed precisely to a desired optical element, such as a waveguide. Consistent with a further aspect of the present disclosure, the lenses may be controlled to be misaligned by varying degrees in order to control the amount of light that is supplied from one substrate to another. Accordingly, the lenses may act as variable optical attenuators to provide uniform optical power levels, for example, or any desired power distribution.

Reference will now be made in detail to the present exemplary embodiments of the present disclosure, which are illustrated in the accompanying drawings. Wherever possible, the same reference numbers will be used throughout the drawings to refer to the same or like parts.

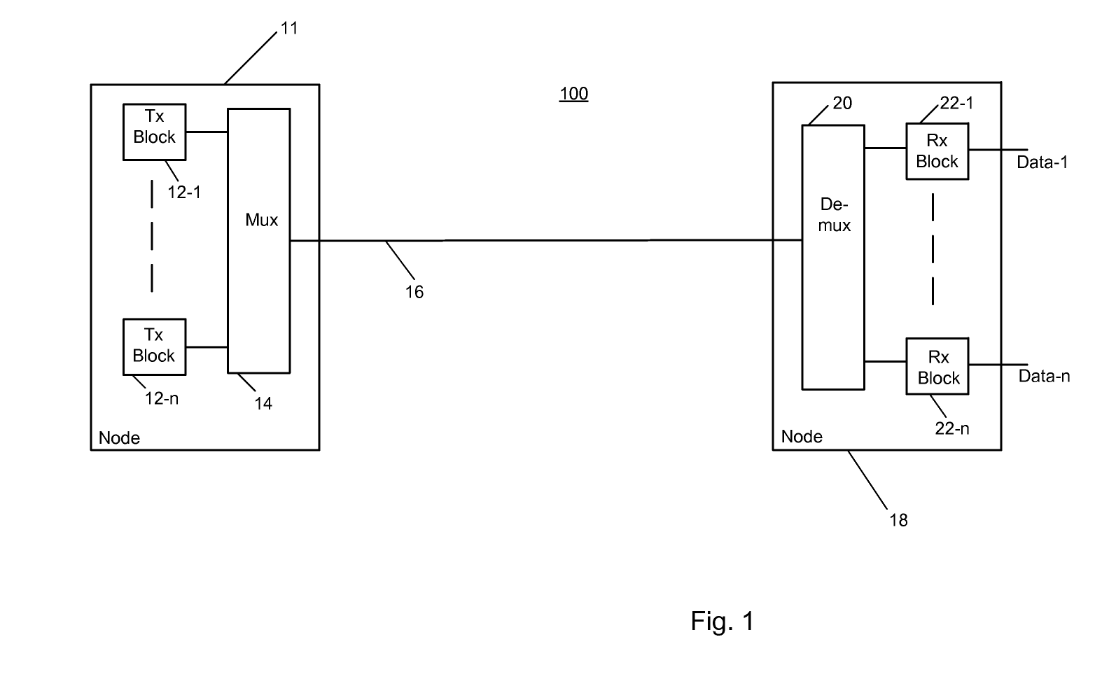

FIG. 1 illustrates an optical link or optical communication system 100 consistent with an aspect of the present disclosure. Optical communication system 100 includes a plurality of transmitter blocks (Tx Block) 12-1 to 12-n provided in a transmit node 11. Each of transmitter blocks 12-1 to 12-n outputs a group of optical signals or channels to a combiner or multiplexer 14, and each optical signal in each group carries an information stream. Multiplexer 14, which may include one or more optical filters, for example, combines each of group of optical signals onto optical communication path 16. Optical communication path 16 may include one or more segments of optical fiber and optical amplifiers, for example, to optically amplify or boost the power of the transmitted optical signals.

As further shown in FIG. 1, a receive node 18 is provided that includes an optical decombiner or demultiplexer 20, which may include one or more optical filters, for example. Optical demultiplexer 20 supplies each group of received optical signals to a corresponding one of receiver blocks (Rx Blocks) 22-1 to 22-n. Each of receiver blocks 22-1 to 22-n, in turn, generates electrical signals in response to the received optical signals. These electrical signals are then further processed to recover data carried by the optical signals. It is understood that each of transmitter blocks 12-1 to 12-n has the same or similar structure and each of receiver blocks 22-1 to 22-n has the same or similar structure.

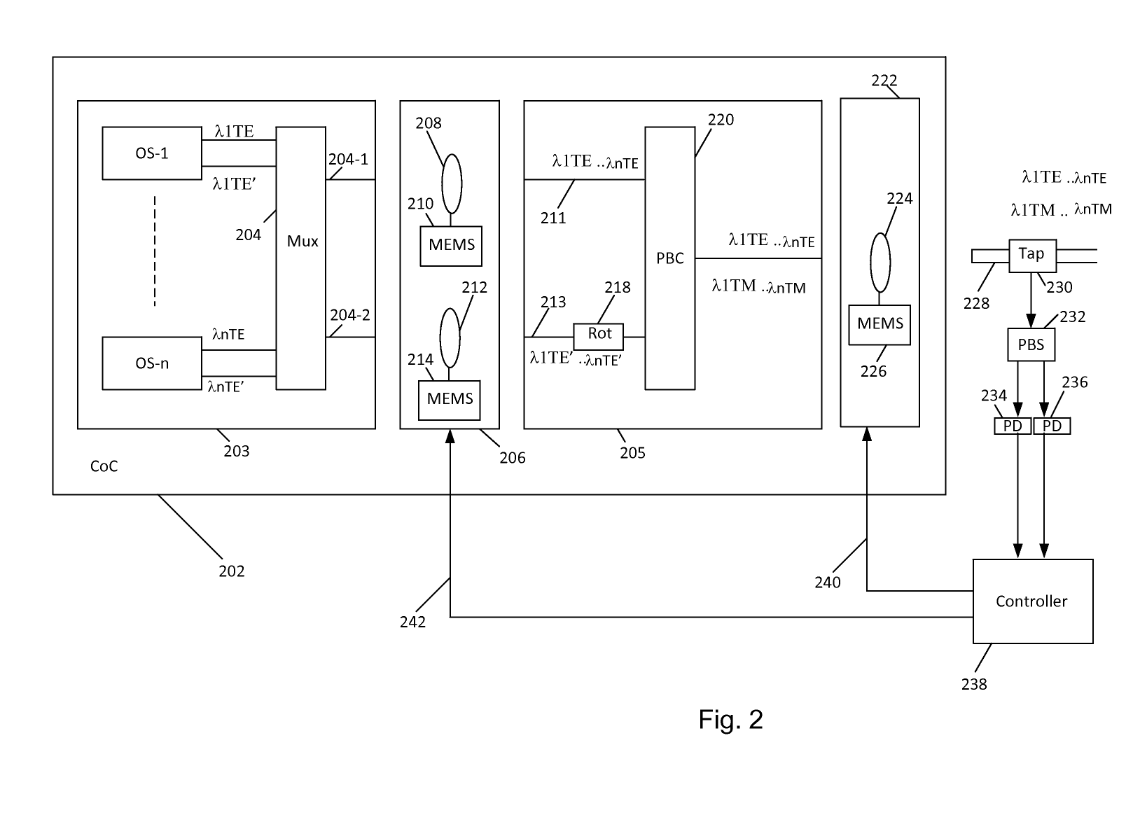

FIG. 2 illustrates an example of transmitter block 12-1. It is understood that transmitter blocks 12-2 to 12-n have the same or similar structure as transmitter block 12-1. Transmitter block 12-1 may include a substrate 202, such as a conventional “chip-on-carrier” substrate (CoC), and first (203) and second (205) may be bonded to CoC 202. Substrate 203 may include indium phosphide or another group IIIV material, such that group IIIV active devices, such as lasers and/or optical amplifiers, may be integrated thereon as a photonic integrated circuit (PIC). For example, as further shown in FIG. 2, optical sources OS-1 to OS-n may be formed on substrate 202, each of which including a laser. Each of optical sources outputs two modulated optical signals, λ1TE and λ1TE′, each at the same wavelength. Each optical signal also has the same polarization, for example, a transverse electric or TE polarization. In a similar fashion, each of remaining optical sources OS-2 to OS-n output pairs of modulated optical signals, each having a TE polarization, and each having the same wavelength, but different than that of other optical signal pairs output from other optical sources OS.

Optical sources OS-1 to OS-n may also include known nested Mach-Zehnder modulators and other components to supply phase and/or amplitude modulated optical signals. The optical signals output from optical sources OS-1 to OS-n may have a modulation format selected from on-off keying (OOK), binary phase shift keying (BPSK), quadrature phase shift keying (QPSK), m-quadrature amplitude modulation (m-QAM, where m is an integer), or combinations thereof.

A multiplexer 204, which may also be provided on substrate 203 receives the optical signals pairs and outputs one signal (λ1TE to λnTE) from each pair at a first output 204-1 and a second signal from each pair (λ1TE′ to λnTE′) at a second output 204-2. These groups of optical signals are next supplied to components on second substrate 205 via lenses 208 and 212 provided in a micro-electromechanical (MEMS) assembly 206.

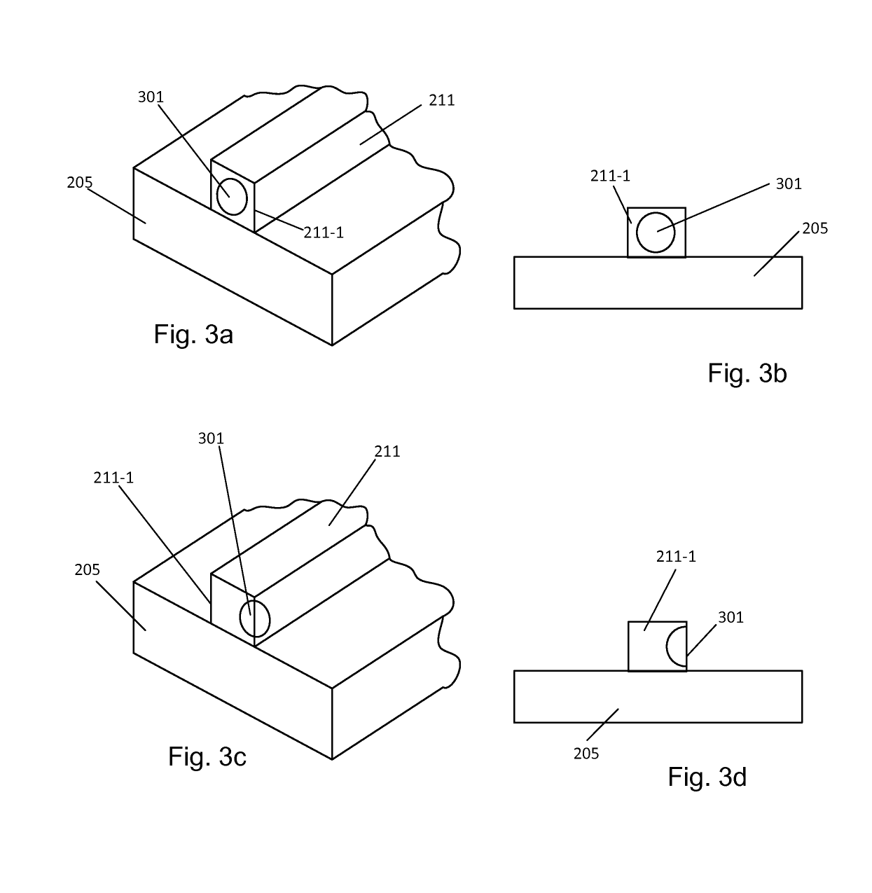

In particular, lenses 208 and 212 may be mechanically coupled to or mounted on MEMS actuators 210 and 214, respectively. MEMS actuators control or adjust the position or orientation of lenses 208 and 212, such that, in one example, the optical signals supplied from multiplexer outputs 204-1 and 204-2 are focused on or directed toward corresponding waveguides 211 and 213 on substrate 205 with minimal loss. The operation of the MEMS actuators 210 and 214 will be described in greater detail below with reference to FIGS. 3a-3d. An example of an optical assembly including MEMS and lenses is disclosed in U.S. Patent Application Publication No. 2011/0158272, the entire contents of which are incorporated herein by reference.

Next, optical signals λ1TE to λnTE propagate on waveguide 211 to a first input of polarization beam combiner (PBC) 220, and optical signals λ1TE′ to λnTE′ propagate on waveguide 213 to polarization rotator (ROT) 218. Polarization rotator 218 rotates the polarization of the incoming optical signals by 90 degrees. Accordingly, since optical signals λ1TE′ to λnTE′ each have a TE polarization, the polarization of these optical signals is rotated 90 degrees. As a result, the optical signal outputs from polarization rotator 218 have a transverse magnetic (TM) polarization, and are thus designated λ1TM to λnTM in FIG. 2.

PBC 220 combines optical signals λ1TE to λnTE having the TE polarization with optical signals λ1TM to λnTM having the TM polarization onto waveguide 228 to provide a polarization multiplexed optical signal. The combined optical signals then pass through lens 224 of MEMS assembly 226. In a manner similar to that described above, the position or orientation of lens 224 is controlled by MEMS actuator 226 to direct the combined optical signals onto fiber 228.

A tap 230 may be provided along optical fiber 228 to provide a power split portion, for example, of the combined optical signals to a polarization beam splitter (PBS) 232. The power split portion may be, for example, 1% to 10%, of the overall power level of the combined optical signal. PBS 232 outputs the power split TE optical signal portions having a TE polarization, namely portions of optical signals λ1TE to λnTE, to photodiode 234. PBS 232 further supplies, through a separate output, the power split TM optical signal portions of λ1TM to λnTM to photodiode 236.

Photodiodes 234 and 236, in turn, supply corresponding electrical signals to controller 234, wherein the electrical signal output from photodiode 234 is indicative of the aggregate power level of optical signals λ1TE to λnTE, and the electrical signal output from photodiode 234 is indicative of the aggregate power level of optical signals λ1TM to λnTM. Accordingly, in response to these electrical signals, controller 238 may supply control signals to MEM actuators 210, 214, and 226 to adjust the positioning and orientation of lenses 208, 212, and 224, respectively, such that a maximum amount of light (optical power) is sensed by photodiodes 234 and 236. In that case, lenses 208, 212, and 224 may be aligned for transmission with minimal loss.

Polarization rotators and polarization beam combiners may be implemented as discrete components or may be integrated on a PIC with lasers and other devices. If implemented as discrete devices, the rotators and PBC may be provided outside a transmitter module housing the PIC or inside the transmitter module. In either case, these devices can take up space and may complicate manufacturing. If these devices are integrated on the PIC, the size of the PIC die may increase, resulting in lower yields. Consistent with the present disclosure, however, the rotator and PBC are integrated on substrate 205 separate from PIC substrate 203.

Substrate 205 may include material that is less expensive and more easily to manufacture than group IIIV substrates. For example, substrate 205 may include silicon or a glass, such as silicon nitride (SiN), silicon oxynitride (SiON), silicon oxide (SiO) or other glasses. Rotator 218 and PBC 220, as well as the waveguides that interconnect these devices, may be formed on substrate 205 using known silicon-based semiconductor processing techniques with reduced cost compared to group IIIV processing costs. In addition, rotator 218 and PBC 220 may be provided with a relatively small form factor or as discrete components mounted to substrate 205.

Accordingly, by providing a MEMS-based, low loss optical interconnection, as noted above, optical devices may be provided on diverse substrates such that a hybrid component can be realized that has reduced manufacturing costs and provides a compact form factor.

In the example discussed above, lenses 208 and 212 are aligned such that substantially all the light received from multiplexer outputs 204-1 and 204-2 is directed toward ends of waveguides 211 and 213, respectively. This scenario is illustrated in FIGS. 3a and 3b in which spot 301, corresponding to the light associated with optical signals supplied from multiplexer output 204-1, is aligned to be substantially centered on face 211-1 of waveguide 211. Consistent with a further aspect of the present disclosure, however, spot 301 may be directed off-axis or aligned by lens 208 so that only a portion of the light impinges on face 211-1, as shown in FIGS. 3c and 3d. Accordingly, in this example, the amount of light transmitted to waveguide 211 is less than that shown in FIGS. 3a and 3b. By controlling the orientation of lens 208, therefore, the amount of optical power supplied to waveguide 211 can be also be adjusted, such that lens 208 under the control of MEMS actuator 210 acts as a variable optical attenuator.

Preferably, the optical power associated with signals supplied from multiplexer outputs 204-1 and 204-2 should be substantially the same or be substantially uniform in order to achieve optimal performance. By varying the amount of light that impinges on waveguides 211 and 213, the optical power associated with optical signals λ1TE to λnTE and λ1TE′ to λnTE′ (which are later rotated to be λ1TM to λnTM) can be controlled to be substantially the same.

Further, controller 238 can adaptively re-orient lenses 208 and 212 based on light sensed by photodiodes 234 and 236 to provide uniform power levels continuously over an extended period of operation. Alternatively, any desired power level distribution can be achieved.

It is noted that lens 224 may be controlled in a similar fashion to either provide maximum transmission to fiber 228, or, if desired, attenuated transmission, so that optical signals λ1TE to λnTE and λ1TM to λnTM have the same power levels as other optical signals output from other transmission blocks 12-2 to 12-n shown in FIG. 1.

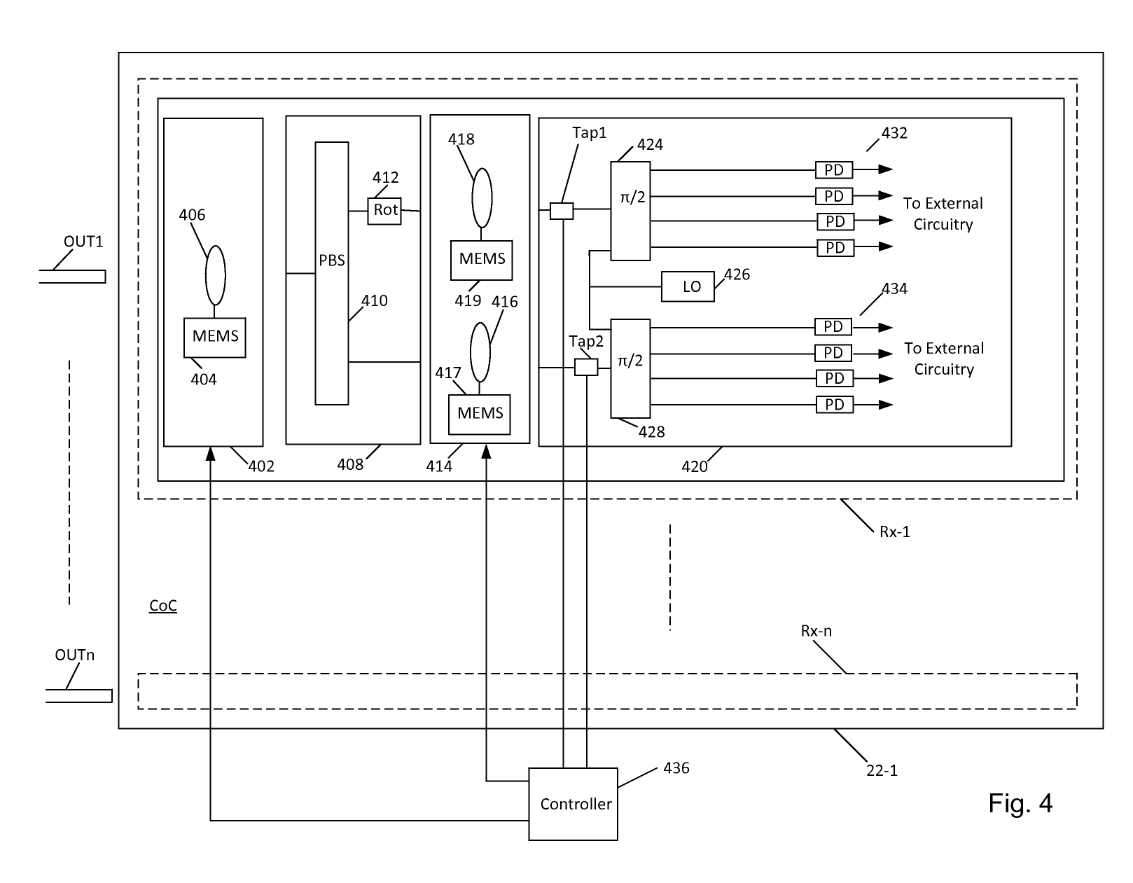

FIG. 4 illustrates an example of a receiver block 22-1 (see FIG. 1) incorporating hybrid components consistent with an aspect of the present disclosure. Receiver block 22-1 includes a plurality of receivers Rx-1 to Rx-n, each of which being provided on a CoC substrate 401 and receiving a power split portion, for example, of optical signals λ1TE to λnTE and λ1TM to λnTM supplied from respective outputs OUT1 to OUTn of demultiplexer 20 shown in FIG. 1. Rx-1, is shown in detail in FIG. 4. Receivers Rx-2 to Rx-n have the same or similar structure as receiver Rx-1. In the example, disclosed herein, receivers Rx-1 to Rx-n are coherent receivers.

Optical signals received from OUT1 are fed to lens 406 of MEMS assembly 404. The orientation and position of lens 406 is adjusted by MEMS actuator 404 to direct the received optical signals to an input of PBS 410. PBS 410 has two outputs, the first supplies optical signals λ1TE to λnTE to lens 416 of MEMS assembly 414 and the second output supplies optical signals λ1TM to λnTM to rotator 412. Rotator 412 rotates the polarization of optical signals X1 TM to λnTM from the TM polarization to the TE polarization. The rotated λ1TM to λnTM optical signals are thus designated λ1TE′ to λnTE′ and are supplied to lens 418 of MEMS assembly 414. Rotator 412 and PBS 410 may be provided on a separate substrate 408, similar to substrate 205 discussed above.

Optical signals λ1TE′ to λnTE′ are supplied to tap Tap1 and optical signals λ1TE to λnTE are supplied to tap Tap2. Taps Tap1 and Tap2 may be provided on or off of substrate 420, such as in MEMS assembly 414. Taps Tap1 and Tap 2 are similar to tap 230 discussed above and may provide power split portions of optical signals λ1TE to λnTE and λ1TE′ to λnTE′ to photodiodes (not shown), which, in turn, supply corresponding electrical signals to controller 436. Controller 436 may then supply control signals based on the received electrical signals to MEMS actuators 404, 417, and 419 to provide maximum optical power transmission or attenuated transmission, as desired, in a manner similar to that discussed above.

The remaining portions of optical signals λ1TE to λnTE and λ1TE′ to λnTE′ output from respective taps Tap1 and Tap2 are fed to corresponding 90 degree optical hybrids 424 and 428 provided on a group IIIV substrate 420, including InP, for example. Optical hybrid circuits 424 and 428 mix the incoming optical signals with light having a wavelength close to one of the received optical signals, e.g., X1, from local oscillator laser 426 to generate mixing products in a known manner. The mixed optical signals are fed to corresponding photodiodes 432 and 434, which may be configured as balanced photodiodes. The electrical outputs of the photodiodes may then be supplied to external circuitry to recover data carried by optical signals λ1TE and λ1TM to λnTM.

As noted above, remaining receivers Rx-2 to Rx-n may have the same components and devices as receiver Rx-1, but the local oscillator in each such receiver may output light having a wavelength that is tuned to be close to a corresponding one of wavelengths λ2 to λn. In this manner, each of receivers Rx-1 to Rx-n supplies electrical signals indicative of data carried by optical signals (both TE and TM) at a respective one of wavelengths λ1 to λn. As further noted above, such electrical signals are subject to further processing to recover data carried by these optical signal.

By providing hybrid components optically interconnected by MEMS assemblies 402 and 414, Rx-blocks 22-1 to 22-n may be manufactured to have a compact form factor and with reduced cost, as is the case with transmitter blocks 12-1 to 12-n discussed above.

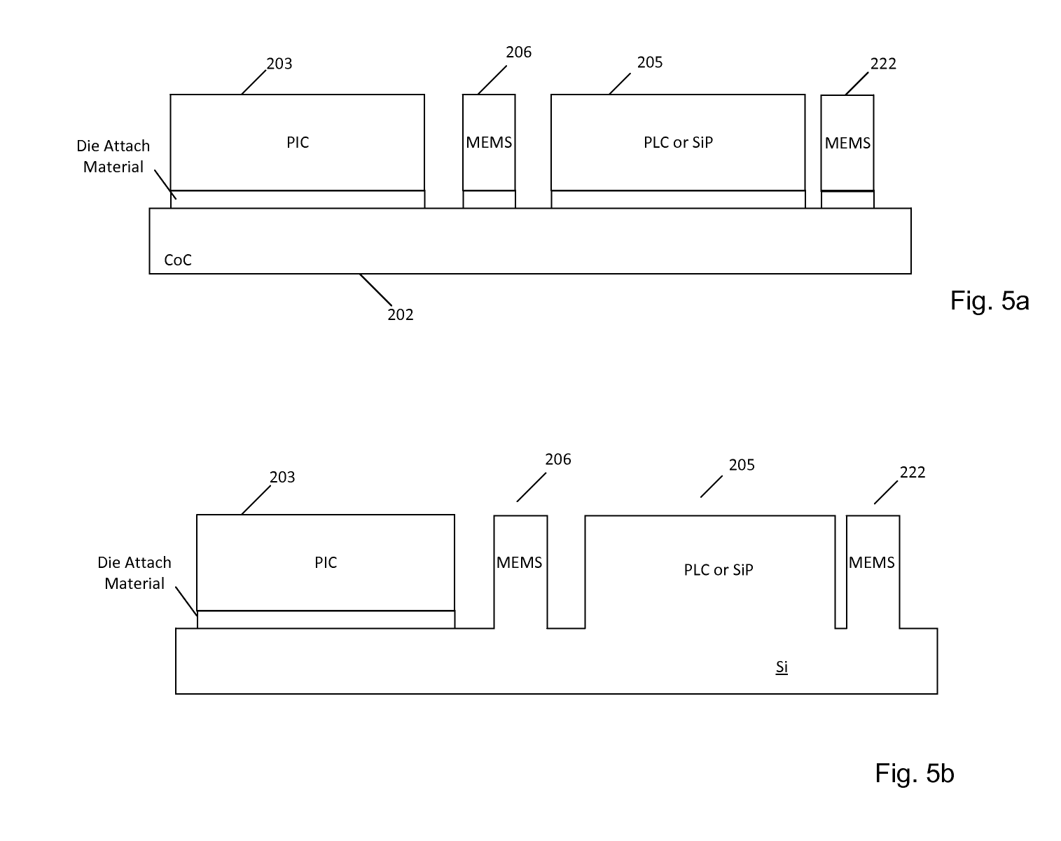

FIG. 5a illustrates a simplified cross-sectional view of receiver block 12-1 shown in FIG. 2. As noted above, receiver block 12-1 includes a group IIIV (or PIC) substrate 203, MEMS assembly 206, silicon or glass substrate 205, and MEMS assembly 222. Each of these substrates may be wafer bonded to CoC 202 in a known manner using an adhesive or die attach material. Substrate 205 and the rotator and PBC provided thereon may be implemented as a planar lightwave circuit (PLC) or as a silicon photonics circuit, in which the rotator and PBC are provided on a silicon substrate.

As shown in FIG. 5b, however, the MEMS assembly, including the actuators, may be implemented in silicon, and, as such, may be formed integral with CoC substrate 202. Accordingly, in this example, only the PIC substrate is die attached to the CoC.

As noted above, in the examples shown in FIGS. 5a and 5b, the MEMS assemblies in the transmitter blocks may be provided integral with the CoC substrate. Consistent with a further aspect of the present disclosure, however, the MEMS assemblies in the receiver blocks 22, e.g., receiver block 22-1 shown in FIG. 4, may also be provided integral with the CoC substrate. In addition, substrate 408, which may be made of the same or similar materials as substrate 205 (discussed above) may also be provided integral with the CoC substrate, and PBS 410 and rotator 412 may be either provided as discrete devices or integrated on substrate 408. Substrate 420, which may include a group IIIV material, such as InP, may be die bonded to CoC substrate shown in FIG. 4.

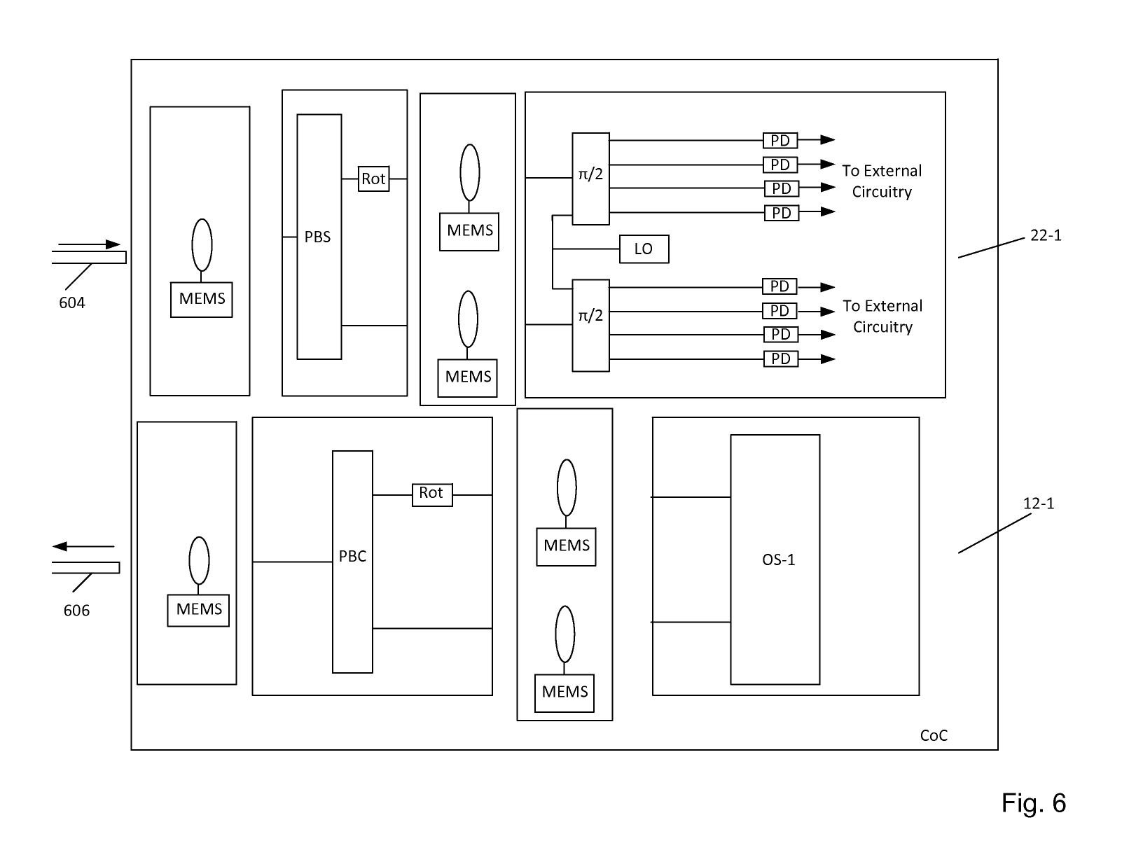

FIG. 6 illustrates an alternative embodiment in which transmitter block 12-1 and receiver block 22-1 are provided on a common substrate or CoC instead of on separate substrates. Here, optical signals are received by receiver block 22-1 from a first waveguide or optical communication path, such as fiber 604, and optical signals output from transmitter block 12-1 are supplied to a second waveguide or optical communication path 606. The structure and operation of receiver block 22-1 and transmitter block 12-1 is similar to or the same as that discussed above.

Other embodiments will be apparent to those skilled in the art from consideration of the specification. For example, polarizers or so-called “strippers” may further be provided on substrates 205 and 222, for example, as well as substrates 412 and 414 to reduce or eliminate any undesired polarization components in the transmitted or received optical signals.

It is intended that the specification and examples be considered as exemplary only, with a true scope and spirit of the invention being indicated by the following claims.

What is claimed is:

1. An apparatus, comprising:
a first substrate (CoC);
second (PIC), third (MEMS assembly), and fourth (PLC or SiP) substrates provided on the first substrate;
an optical source, including a laser, being provided on the second substrate, the optical source outputting first and second optical signals from the second substrate;
first and second lenses provided on the third substrate, the first lens directing at least a portion of the first optical signal to a first waveguides provided on the fourth substrate, and the second lens directing at least a portion of the second optical signal to a second waveguide on the fourth substrate;
a rotator provided on the provided on the fourth substrate, the rotator being configured to rotate a polarization of said at least a portion of the first optical signal to provide a rotated optical signal; and
a polarization beam combiner provided on the fourth substrate, the polarization beam combiner receiving the rotated optical signal and said at least a portion of the second optical signal and outputting a polarization multiplexed optical signal.

2. An apparatus in accordance with claim 1, wherein the rotated optical signal has a transverse magnetic (TM) polarization and said at least a portion of the second optical signal has a transverse electric (TE) polarization.

3. An apparatus in accordance with claim 1, wherein the second substrate includes a group IIIV material.

4. An apparatus in accordance with claim 3, wherein the group IIIV material includes indium phosphide (InP).

5. An apparatus in accordance with claim 4, wherein the fourth substrate includes a material selected from the group of silicon, silicon nitride, silicon oxynitride, and silicon oxide.

6. An apparatus in accordance with claim 1, wherein the apparatus further including:
a fifth substrate; and
a third lens provided on the fifth substrate, the third lens being configured to direct the polarization multiplexed optical signal to an optical fiber.

7. An apparatus in accordance with claim 1, further including a microelectromechical system (MEMS) actuator that is mechanically coupled to the first lens, the MEMS actuator adjusting an orientation of the first lens.

8. An apparatus, comprising:
a first substrate (CoC); and
a second substrate (PIC);
an optical source, including a laser, being provided on the second substrate, the optical source outputting first and second optical signals from the second substrate;
first and second lenses provided on a first portion of the first substrate,
first and second MEMS actuators integrally formed on the first substrate, the first and second lenses being mechanically coupled to the first and second MEMS actuators, respectively, the first lens directing at least a portion of the first optical signal to a first waveguide, and the second lens directing at least a portion of the second optical signal to a second waveguide, the first and second waveguides being provided on a second portion of the first substrate;
a rotator provided on a third portion of the first substrate, the rotator being configured to rotate a polarization of said at least a portion of the first optical signal to provide a rotated optical signal; and
a polarization beam combiner provided on a fourth portion of the first substrate, the polarization beam combiner receiving the rotated optical signal and said at least a portion of the second optical signal and outputting a polarization multiplexed optical signal, the polarization beam combiner and the rotator being integrally formed with the first substrate.

9. An apparatus in accordance with claim 8, wherein the rotated optical signal has a transverse magnetic (TM) polarization and said at least a portion of the second optical signal has a transverse electric (TE) polarization.

10. An apparatus in accordance with claim 8, wherein the second substrate includes a group IIIV material.

11. An apparatus in accordance with claim 10, wherein the group IIIV material includes indium phosphide (InP).

12. An apparatus in accordance with claim 11, wherein the fourth substrate includes a material selected from the group of silicon, silicon nitride, silicon oxynitride, and silicon oxide.

13. An apparatus in accordance with claim 8, the apparatus further including:
a third lens provided on a fifth portion of the first substrate, the third lens being configured to direct the polarization multiplexed optical signal to an optical fiber.

14. An apparatus, comprising:
a first substrate (CoC);
second (PLC or SiP), third (MEMS with lens), and fourth (PIC) substrates provided on the first substrate;
a polarization beam splitter provided on the second substrate, the polarization beam splitter receiving a polarization multiplexed optical signal and outputting a first optical signal having a first polarization and a second optical signal having a second polarization;
a polarization rotator provided on the second substrate, the polarization rotator being configured to rotate the first polarization of the first optical signal to provide a rotated first optical signal;
a first lens that receives the rotated first optical signal and a second lens that receives the second optical signal, the first and second lenses being provided on the third substrate,
a plurality of photodiodes provided on the fourth substrate, at least one of the plurality of photodiodes receiving at least a portion of one of the first and second optical signals directed from the first and second lenses, respectively.

15. An apparatus in accordance with claim 14, wherein the rotated first optical signal has a transverse electric (TE) polarization and said at least a portion of the second optical signal has the TE polarization.

16. An apparatus in accordance with claim 14, wherein the fourth substrate includes a group IIIV material.

17. An apparatus in accordance with claim 16, wherein the group IIIV material includes indium phosphide (InP).

18. An apparatus in accordance with claim 14, wherein the second substrate includes a material selected from the group of silicon, silicon nitride, silicon oxynitride, and silicon oxide.

19. An apparatus in accordance with claim 14, wherein the lens is a first lens, the apparatus further including:
a fifth substrate; and
a third lens provided on the fifth substrate, the third lens being configured to direct the polarization multiplexed optical signal to an optical fiber.

20. An apparatus in accordance with claim 8, the apparatus further including:
a fifth substrate;
a third lens provided on the fifth substrate, the third lens being configured to direct the polarization multiplexed optical signal to a portion of the second substrate, such that the polarization multiplexed optical signal is transmitted to the polarization beam splitter.

21. An apparatus in accordance with claim 14, further including a MEMS actuator mechanically coupled to the first lens.
